(19) United States
(12) Patent Application Publication
(10) Pub. No.: US 2023/0016441 A1
(43) Pub. Date: Jan. 19, 2023

(54) INDUCTION COOKING DEVICE

(71) Applicant: BSH Hausgeräte GmbH, Munich (DE)

(72) Inventors: Jorge Felices Betran, Huesca (Spain) (ES); Alvaro Tomas Latorre Molins, Zaragoza (ES); Ignacio Lope Moratilla, Zaragoza (ES); Maria Elena Moya Albertin, Zaragoza (ES); Javier Serrano Trullen, Zaragoza (ES)

(21) Appl. No.: 17/781,745

(22) PCT Filed: Jan. 13, 2021
(86) PCT No.: PCT/EP2021/050537

§ 371 Date: Jun. 2, 2022

(30) Foreign Application Priority Data
Jan. 31, 2020 (EP) 20382058.4

(51) Int. Cl. H05B 6/42; F28F 21/06; F28F 13/18

(52) U.S. Cl. CPC H05B 6/42; F28F 21/06; F28F 13/18; H05B 2206/022

(57) ABSTRACT

An induction cooking appliance apparatus includes an induction coil, and a coil carrier configured to hold the induction coil and including a heat dissipation unit for dissipating heat emitted by the induction coil.

The invention relates to an induction cooking appliance apparatus as claimed in the preamble of claim 1.

Induction cooking appliances with holding apparatuses for holding at least one induction coil are already known from the prior art. Known induction cooking appliances of a first type have a layer comprising mica paper, glass-fiber cloth and ceramic paper on which the induction coil is fastened for holding purposes by means of a silicon. Known induction cooking appliances of a second type have a housing, typically manufactured from a plastic material, which is provided for receiving and holding the induction coil.

The object of the invention consists in particular in, but is not limited to, supplying a generic apparatus with improved properties in terms of efficiency. The object is achieved according to the invention by the features of claim 1, while advantageous embodiments and developments of the invention are disclosed in the subclaims.

The invention is based on an induction cooking appliance apparatus, in particular an induction hob apparatus, with at least one coil carrier for holding at least one induction coil.

It is proposed that the coil carrier has a heat dissipation unit, which is provided to dissipate heat emitted by the induction coil.

By way of such an embodiment, it is advantageously possible to provide an induction cooking appliance apparatus with improved properties in terms of efficiency, in particular in terms of energy efficiency and/or material efficiency and/or cost efficiency. An improved dissipation of the heat emitted by the induction coil advantageously enables an operating temperature of the induction coil to be reduced, as a result of which it is particularly advantageously possible to reduce temperature-dependent electrical losses which can be caused inter alia by electrical resistances and/or parasitic capacitances, for example. On account of the reduced electrical losses, it is further advantageously possible to increase an electrical output emitted by the induction coil and/or to provide the same continuously over a longer period of time. Furthermore, it is advantageously conceivable that a number of windings of the induction coil can be reduced at a constant electrical output, as a result of which it is advantageously possible to achieve material cost savings. It is moreover conceivable that copper coils can be replaced by aluminum coils, as a result of which it is advantageously possible to achieve particularly high material cost savings.

An “induction cooking appliance apparatus” is to be understood in particular to mean at least one part, in particular a subassembly, of an induction cooking appliance, in particular of an induction hob. The induction cooking appliance could be embodied for example as an induction grill and/or as an induction oven and/or as a combination appliance with additional microwave functionality. The induction cooking appliance is preferably embodied as an induction hob. It is conceivable in particular that the induction hob is embodied as a matrix induction hob. In particular, the induction cooking appliance apparatus, in particular the induction hob apparatus, can also comprise the entire induction cooking appliance, in particular the entire induction hob.

A “coil carrier” is to be understood in particular to mean a unit which is provided to receive at least one induction coil of the induction cooking appliance apparatus or of an induction cooking appliance comprising the induction cooking appliance apparatus and in particular to hold the windings of the induction coil in position. The coil carrier can be provided to hold several induction coils. The coil carrier is preferably provided to receive exactly one induction coil and to hold the windings of the exactly one induction coil in position. The coil carrier has in particular at least one base carrier element. The base carrier element has a top side and an underside disposed opposite the top side. In an installation position of the induction cooking appliance apparatus, the top side of the base carrier element points upward, in particular in the direction of a hob plate of the induction cooking appliance having the induction cooking appliance apparatus. The coil carrier has in particular at least one coil receiving element. The coil receiving element is provided in particular to receive the induction coil. The coil receiving element is arranged in particular on the top side of the base support element of the coil carrier. The coil receiving element is arranged in particular centrally on the top side of the base carrier element with respect to a main extension plane of the coil carrier. The coil receiving element can be embodied in particular as an elliptical projection of the base carrier element. The coil carrier can have in particular further units and/or further elements, for example through-flow openings to a cable guide. The induction cooking appliance apparatus can have in particular several coil carriers. The coil carriers of the induction cooking appliance apparatus can in particular be embodied identically to one another. The induction cooking appliance apparatus advantageously has a number of coil carriers which corresponds to a number of induction coils of the induction cooking appliance apparatus or of an induction cooking appliance having the induction cooking appliance apparatus.

A “main extension plane” of a modular unit is to be understood in particular to mean a plane which is parallel to a largest side area of a smallest notional cuboid, which only just fully encloses the modular unit, and in particular runs through the center point of the cuboid.

A “heat dissipation unit” is to be understood in particular to mean a unit which is provided to dissipate heat emitted by the induction coil. In particular, the heat dissipation unit is provided exclusively to dissipate the heat emitted by the induction coil. The heat dissipation unit is in particular embodied to be different from a cooling unit, which is provided for example to cool inverters, rectifiers and/or further electrical and/or electronic components, of the induction cooking appliance apparatus or of an induction cooking appliance having the induction cooking appliance apparatus. A heat flux for the dissipation of the heat emitted by the induction coil advantageously takes place by means of heat conduction. Alternatively or in addition, it is conceivable for the heat flux for the dissipation of the heat emitted by the induction coil to take place by means of thermal radiation and/or by means of convection.

“Provided” is to be understood in particular to mean especially designed and/or equipped. An object being provided for a particular function is to be understood in particular to mean that the object fulfills and/or carries out this particular function in at least one application and/or operating state.

It is further proposed that the coil carrier is embodied in one piece. As a result, a manufacturing process of the coil carrier can advantageously be simplified. “In one piece” is to be understood in particular to mean connected with a material fit, for example by a welding process, an adhesive bonding process, an injection molding process and/or another process appearing suitable to the person skilled in the art, and/or advantageously understood to mean molded in one piece, such as by producing from a cast iron and/or by producing in a single or multi-component injection molding method and advantageously from a single blank. The heat dissipation unit of the coil carrier and all further units and/or further elements of the coil carrier, in particular the base carrier and the coil receiving element, are preferably embodied molded in one piece. In particular, the heat dissipation unit of the coil carrier and all other units and/or elements of the coil carrier are manufactured in a single or multi-component injection molding method. Alternatively, it would be conceivable for the heat dissipation unit to be manufactured separately and connected with a material fit to the at least one element of the coil carrier, in particular to the base carrier element, for example by means of adhesive bonding.

It is also proposed that the heat dissipation unit has at least one rib-shaped first heat dissipation element. This advantageously enables a surface of the heat dissipation unit to be raised, resulting in a particularly efficient dissipation of the heat emitted by the induction coil. The raised surface of the heat dissipation unit in particular enables an efficient transmission of the heat to the air surrounding the heat dissipation unit. In this context, “rib-shaped” is to be understood in particular to mean a geometric shape of an object, the largest side area of which is greater than a next smaller side area relative to the largest side area at least by a factor of 2, in particular at least by a factor of 4, advantageously at least by a factor of 6, particularly advantageously at least by a factor of 8, preferably at least by a factor of 9 and particularly preferably at least by a factor of 10. In particular, the at least one rib-shaped first heat dissipation element is arranged such that its largest side area runs substantially perpendicular to the main extension plane of the coil carrier. In this context, “substantially perpendicular” is to be understood to mean in particular an orientation of a direction relative to a reference direction, wherein compared to the reference direction the direction has an angle of at least 75°, advantageously of at least 80°, particularly advantageously of at least 85° and preferably of exactly 90°.

It is furthermore proposed that the heat dissipation unit has at least one rib-shaped second heat dissipation element. This advantageously enables a dissipation of the heat emitted by the induction coil to be further improved. In particular, the heat dissipation unit has a large number of in particular rib-shaped further heat dissipation elements.

The first heat dissipation element and the second heat dissipation element could in particular be aligned at an angle to one another. Advantageously, the first heat dissipation element is arranged at least substantially parallel to the second heat dissipation element. This advantageously makes it possible to achieve a particularly space-saving arrangement of the heat dissipation elements, as a result of which a particularly compact design of the induction cooking appliance apparatus can be achieved. In this context, “substantially parallel” is to be understood in particular to mean an orientation of a direction relative to a reference direction, in particular in a plane, wherein compared to the reference direction the direction has a deviation of in particular less than 8°, advantageously less than 5° and particularly advantageously less than 2°.

In particular, the first and/or the second heat dissipation element could be oriented at least partially along a circumferential direction of the coil carrier. Advantageously, however, the first heat dissipation element is oriented radially outward. In particular, the first heat dissipation element and the second heat dissipation element are oriented radially outward. This advantageously enables a heat dissipation of the heat emitted by the induction coil to be further improved. In particular, the air surrounding the heat dissipation element and heated by the heat dissipation element can be advantageously guided away particularly efficiently. The heat dissipation element being “oriented radially outward” is understood to mean in particular that a direction of a longest edge of the heat dissipation element runs substantially parallel to the main extension plane of the coil carrier from the inside out, in particular from an inner oval region of the coil carrier toward an outer edge of the coil carrier.

It is furthermore proposed that the coil carrier has at least one recess in an outer end region of the first heat dissipation element for the purpose of guiding away heated air. This advantageously enables a heat dissipation of the heat emitted by the induction coil to be further improved. In particular, heated air can advantageously be guided away in an improved manner. In particular, a main extension plane of the first heat dissipation element runs in the direction of the recess. The recess is arranged in particular in a frame element of the coil carrier. The frame element of the coil carrier runs in particular along a circumferential direction, in particular over a full circumference, of the coil carrier from an outer edge of the base body element of the coil carrier perpendicular to the main extension plane of the coil carrier. The recess can be embodied in particular in a semicircular shape. In particular, the air surrounding the heat dissipation element is heated by means of heat conduction and/or convection and/or thermal radiation from the surface of the first and/or of the second and/or of a further heat conduction element to the air molecules surrounding the heat dissipation element. The heated air is guided away in particular independently and in particular without any additional energy supply, namely in particular on account of a negative temperature gradient from the surface of the heat dissipation element in the direction of the recess. An “outer end region” is to be understood in particular to mean a region of the heat conduction element which has a minimal distance from a marginal region of the coil carrier running perpendicular to a main extension direction of the coil carrier. A “main extension direction” of an object is to be understood here in particular to mean a direction which runs parallel to a longest edge of a smallest notional cuboid, which only just fully encloses the object.

The heat dissipation unit could in particular have only exactly one heat dissipation section. Advantageously, however, the heat dissipation unit has at least two heat dissipation sections disposed at a distance from one another. This advantageously enables an in particular even dissipation of the heat emitted by the induction coil. A “heat dissipation section” is to be understood in particular to mean a subregion of the heat dissipation unit which has at least one heat dissipation element of the heat dissipation unit, in particular at least one of the rib-shaped heat dissipation elements of the heat dissipation unit. The heat dissipation unit preferably has a large number of heat dissipation sections, which are in particular arranged at a distance from one another and are in particular distributed evenly with respect to the area of the underside of the base carrier element of the coil carrier.

Furthermore, it is proposed that the heat dissipation sections are arranged symmetrically to one another. This advantageously enables an even heat dissipation to take place over the entire area of the underside of the base carrier element of the coil carrier. It is further advantageously possible to improve a molding process of the heat dissipation unit.

In particular, the heat dissipation unit could be embodied from a metal and/or a ceramic material. It is further proposed that the heat dissipation unit has a plastic material with a thermal conductivity of at least 0.2 W/(K m) and in particular consists of such a material. This advantageously makes it possible to improve a production process. In particular, it is possible to manufacture a heat dissipation unit with advantageous properties in terms of an efficient dissipation of the heat emitted by the induction coil, in particular in an efficient and/or cost-effective manner, in particular in a single or multi-component injection molding process. In particular, the heat dissipation unit could have polyphenylene sulfide (PPS) with a thermal conductivity of at least 0.25 W/(K m) and in particular consist of polyphenylene sulfide (PPS). Alternatively or in addition, it would be conceivable for the heat dissipation unit to have polyamide 66 (PA 66) with a thermal conductivity of at least 0.23 W/(K m) and in particular consist of PA 66. Furthermore, it would be conceivable alternatively or in addition for the heat dissipation unit to have a thermosetting plastic, for example an epoxy resin, with a thermal conductivity of at least 0.2 W/(K m) and in particular consist of such a material.

It is also proposed that the plastic material has a temperature resistance of at least 200° C. This advantageously enables a particularly resilient and/or durable heat dissipation unit to be provided. The plastic material preferably has a temperature resistance of at least 250°. A “temperature resistance” of an object and/or material is to be understood to mean in particular an object-specific and/or material-specific temperature and/or an object-specific and/or material-specific temperature range to which the object and/or material can be subjected, in particular continuously and directly, without causing the object and/or material properties which are key to ensuring the functionality of the object and/or material in order to fulfill an envisaged function to be changed beyond a degree which is tolerable for the envisaged application and/or function of the object and/or material. In particular, the object and/or material is able to function at the temperature and/or in the temperature range which defines the temperature resistance of the object and/or material and/or is not impaired and/or damaged thereby.

It is further proposed that the heat dissipation unit has at least one coating to improve the thermal conductivity. This advantageously enables a dissipation of the heat emitted by the induction coil to be further improved. In particular, the heat dissipation unit has a core material, which is embodied as a substrate for the coating. The coating has in particular a material with a high thermal conductivity, in particular compared with the core material of the heat dissipation unit, and in particular consists of such a material. A “high thermal conductivity” is to be understood in particular to mean a heat conductivity of at least 15 W/(K m), advantageously of at least 20 W/(K m), particularly advantageously of at least 25 W/(K m), preferably of at least 30 W/(K m) and particularly preferably of at least 35 W/(K m). The coating has in particular a material with good electrical insulation properties and in particular consists of such a material. A “material with good electrical insulation properties” is to be understood in particular to mean a material with a specific electrical resistance of at least 10¹⁰ Ω cm, advantageously of at least 10¹¹ Ω cm, particularly advantageously of at least 10¹² Ω cm, preferably of at least 10¹³ Ω cm and particularly preferably of at least 10¹⁴ Ω cm and with a dielectric strength of at least 15 kV/mm, advantageously of at least 20 kV/mm, particularly advantageously of at least 25 kV/mm, preferably of at least 30 kV/mm and particularly preferably of at least 35 kV/mm. The coating can have in particular a ceramic material with a high thermal conductivity and good electrical insulation properties, preferably aluminum oxide, and can in particular comprise such a material. It would alternatively be conceivable for the heat dissipation unit to have a core material with a high thermal conductivity, which is coated with a coating having good electrical insulation properties. In particular, the heat dissipation unit could have a metallic core material with a high thermal conductivity, for example an aluminum alloy, which is coated with a plastic material having good electrical insulation properties, for example polyphenylene sulfide (PPS). The coating can be applied in particular by a coating process, in particular a screen printing process, by spin coating, by dip coating, by a sol-gel process, by spraying on, by an inkjet printing process, by a chemical vapor deposition (CVD) process and/or by a physical vapor deposition (PVD) process, onto the core material of the heat dissipation unit.

In this context, the induction cooking appliance apparatus should not be restricted to the use and embodiment described above. In particular, the induction cooking appliance apparatus can have a number of individual elements, parts and units deviating from a number mentioned herein for fulfilling a mode of operation described herein.

Further advantages result from the following description of the drawing. The drawing shows exemplary embodiments of the invention. The drawing, the description and the claims contain numerous features in combination. The person skilled in the art will expediently also consider the features individually and combine them to form useful further combinations.

In the drawing:

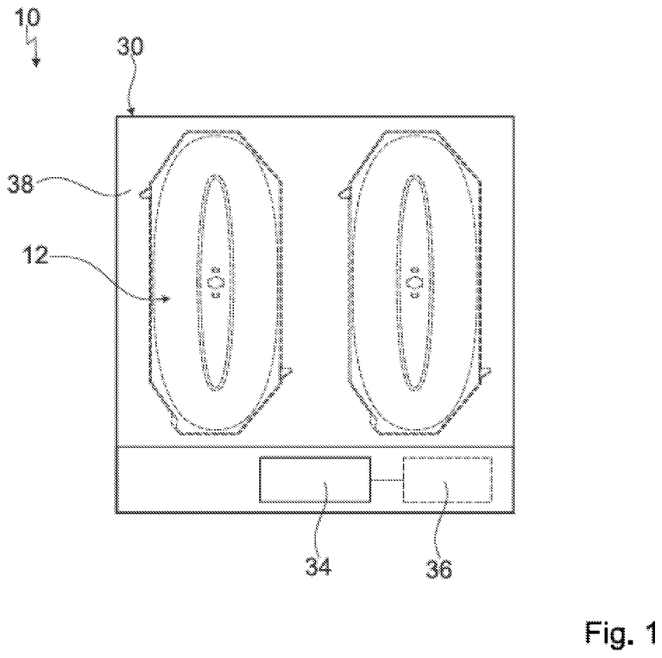

FIG. 1 shows an induction cooking appliance with an induction cooking appliance apparatus in a schematic view,

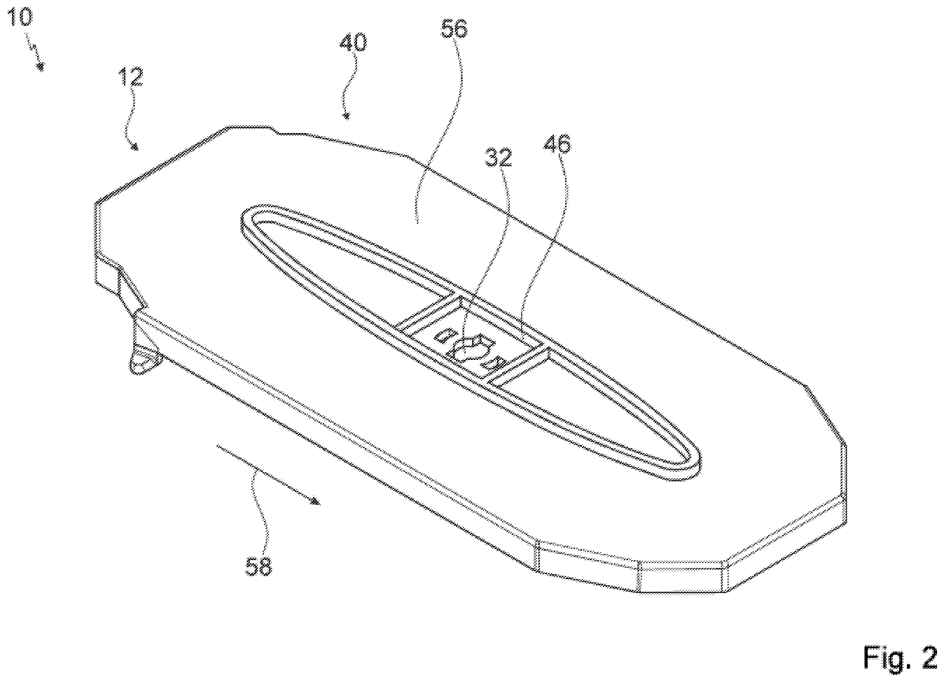

FIG. 2 shows a coil carrier of the induction cooking appliance apparatus in a schematic view,

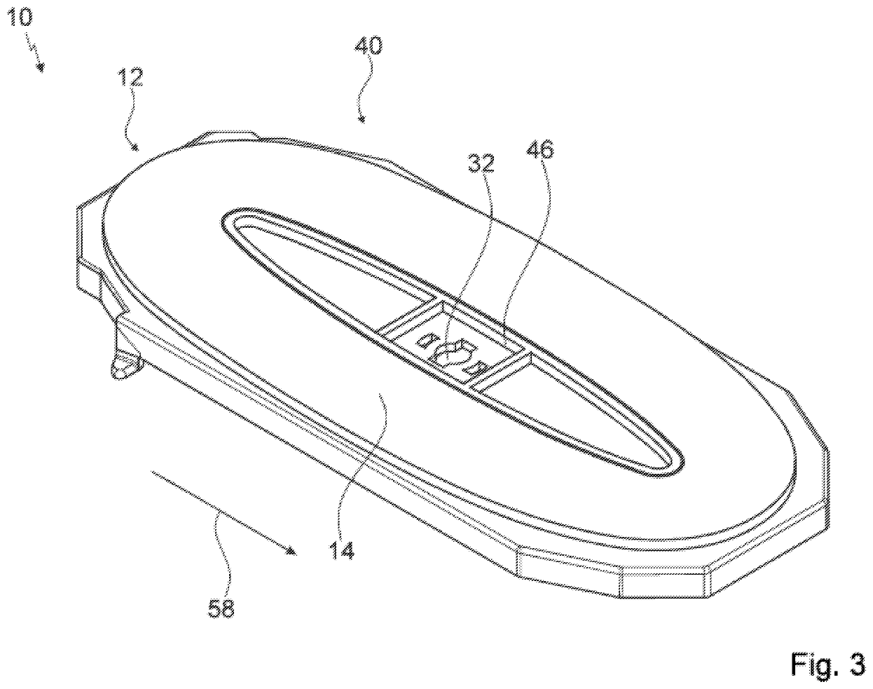

FIG. 3 shows the coil carrier with an induction coil in a schematic view,

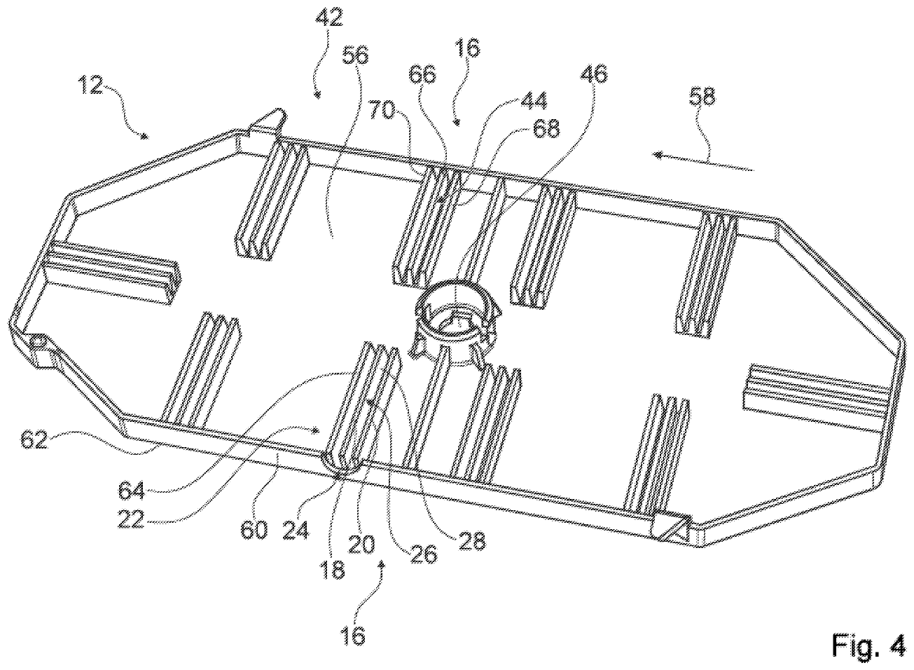

FIG. 4 shows the coil carrier with a heat dissipation unit in a schematic view, and

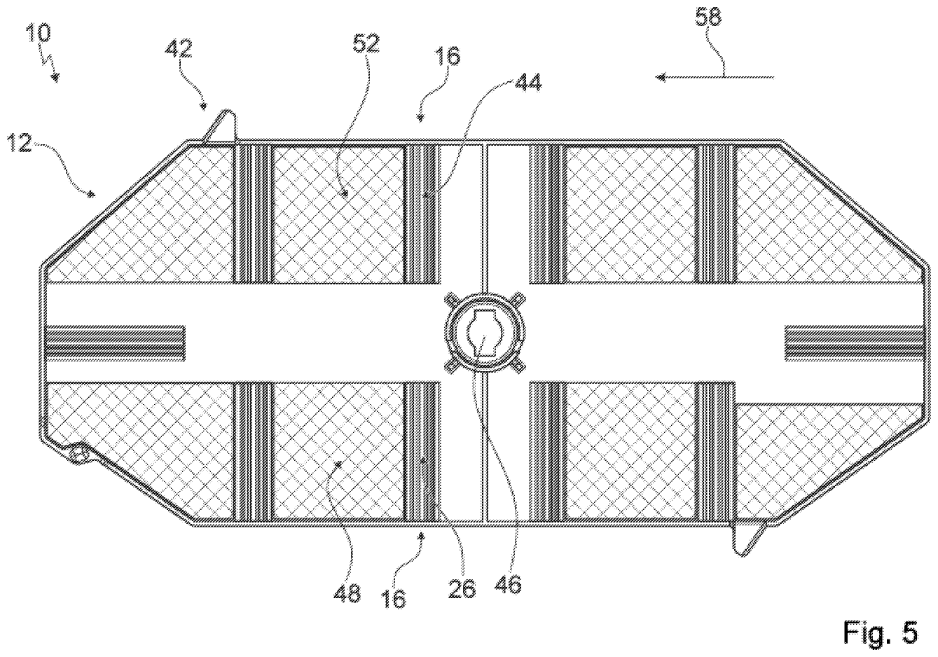

FIG. 5 shows the coil carrier with the heat dissipation unit and ferrites in a schematic view.

FIG. 1 shows an induction cooking appliance 30. The induction cooking appliance is embodied as an induction hob. The induction cooking appliance 30 has a hob plate 38. The induction cooking appliance 30 has a user interface 34. The user interface 34 is arranged on a side of the hob plate 38 facing toward a user. The user interface 34 is provided for the user to input operating settings and for information to be output to the user of the induction cooking appliance 30. The induction cooking appliance 30 has a control unit 36. The control unit 36 is provided to control at least one function of the induction cooking appliance 30. The control unit 36 is arranged below the hob plate 38 on a side facing away from the user.

The induction cooking appliance 30 has an induction cooking appliance apparatus 10. The induction cooking appliance apparatus 10 is embodied as an induction hob apparatus. The induction cooking appliance apparatus 10 comprises a coil carrier 12. The coil carrier 12 of the induction cooking appliance apparatus 10 is arranged on the side facing away from the user below the hob plate 38 of the induction cooking appliance 30.

FIG. 2 shows the coil carrier 12 of the induction cooking appliance apparatus 10 in a schematic view. The coil carrier 12 has a base carrier element 56. In FIG. 2, the coil carrier is represented in a view onto a top side 40 of the base carrier element 56. The coil carrier 12 is provided to hold an induction coil 14 of the induction cooking appliance 30. The coil carrier 12 has a coil receiving element 32. The coil receiving element 32 is provided to receive and position the induction coil 14 of the induction cooking appliance 30 (see FIG. 3). The coil receiving element 32 is arranged on the top side 40 of the base carrier element 56. The coil receiving element 32 is embodied as an elliptical projection about a center point 46 of the base carrier element 56 and extends substantially perpendicular to a main extension plane 58 of the coil carrier 12.

FIG. 3 shows the coil carrier 12 of the induction cooking appliance apparatus 10 with the induction coil 14 of the induction appliance 30. The induction coil 14 has several windings (not shown). The induction coil 14 is received by the coil receiving element 32 of the coil carrier 12. The windings of the induction coil 14 are wound in the shape of an ellipse about the coil receiving element 32. The coil receiving element 32 holds the windings of the induction coil 14 in position.

FIG. 4 shows the coil carrier 12 of the induction cooking appliance apparatus 10 in a view onto an underside 42 of the base carrier element 56. The coil carrier 12 has a heat dissipation unit 16. The heat dissipation unit 16 is provided for dissipating heat emitted by the induction coil 14 in an operating state of the induction cooking appliance 30.

The coil carrier 12 is embodied in one piece. The heat dissipation unit 16 of the coil carrier 12 has a plastic material with a thermal conductivity of at least 0.2 W/(K m). The heat dissipation unit 16 has a plastic material with a temperature resistance of at least 200 C. The heat dissipation unit 16 consists in particular of a thermoplastic material, namely polyphenylene sulfide (PPS) with a thermal conductivity of at least 0.25 W/(K m) and a temperature resistance of at least 250° C. The coil carrier 12 complete with the heat dissipation unit 16 is manufactured in particular from one piece from PPS in an injection molding process.

The heat dissipation unit 16 has a first heat dissipation element 18. The first heat dissipation element 18 is embodied to be rib-shaped. The first heat dissipation element 18 is oriented radially outward. The heat dissipation unit 16 has a second heat dissipation element 20. The second heat dissipation element 20 is embodied to be rib-shaped. The first heat dissipation element 18 is arranged at least substantially parallel to the second heat dissipation element 20.

The heat dissipation unit 16 has a coating 28 to improve the thermal conductivity. The coating 28 consists of an aluminum oxide with a thermal conductivity of at least 35 W/(K m). The coating 28 is applied to the heat dissipation unit 16 by means of a chemical vapor deposition process.

The coil carrier 12 has a margin 60. The margin 60 runs circumferentially along an outer edge 62 of the base carrier element 56 of the coil carrier 12. The margin 60 extends essentially perpendicular to a main extension plane 58 of the coil carrier 12. In an outer end region 22 of the first heat dissipation element 18 of the heat dissipation unit 16, the margin 60 of the coil carrier 12 has a recess 24. The recess 24 is provided for guiding away heated air.

The heat dissipation unit 16 embodies a heat dissipation section 26. The heat dissipation section 26 comprises the first heat dissipation element 18, the second heat dissipation element 20 and a third heat dissipation element 64. The heat dissipation unit 16 embodies a further heat dissipation section 44. The further heat dissipation section 44 comprises a further first heat dissipation element 66, a further second heat dissipation element 68 and a further third heat dissipation element 70. The further first heat dissipation element 66, the further second heat dissipation element 68 and the further third heat dissipation element 70 are embodied to be rib-shaped and are arranged substantially parallel to one another. The heat dissipation section 26 and the further heat dissipation section 44 are arranged at a distance from one another. The heat dissipation section 26 and the further heat dissipation section 44 are arranged symmetrically to one another.

FIG. 5 shows the coil carrier 12 with the heat dissipation unit 16. A ferrite 48 of the induction cooking appliance 30 is arranged next to the heat dissipation section 26 of the heat dissipation unit 16. A further ferrite 52 of the induction cooking appliance 30 is arranged next to the further heat dissipation section 44. In an operating state of the induction cooking appliance 30, the ferrites 48, 52 are provided to concentrate an electromagnetic field generated by the induction coil 14 and to at least substantially prevent a radiation of this electromagnetic field in the direction of the underside 42.

Only one of the objects present multiple times in the figures is provided with a reference character in each case.

### REFERENCE CHARACTERS

10 Induction cooking appliance apparatus
12 Coil carrier
14 Induction coil
16 Heat dissipation unit
18 First heat dissipation element
20 Second heat dissipation element
22 Outer end region
24 Recess
26 First heat dissipation section
28 Coating
30 Induction cooking appliance
32 Coil receiving element
34 User interface
36 Control unit
38 Hob plate
40 Top side
42 Underside
44 Further heat dissipation section
46 Center point
48 Ferrite
52 Further ferrite
56 Base carrier element
58 Main extension plane
60 Margin
62 Outer edge
64 Third heat dissipation element
66 Further first heat dissipation element
68 Further second heat dissipation element
70 Further third heat dissipation element

1-13. (canceled)

14. An induction cooking appliance apparatus, comprising:
an induction coil; and
a coil carrier configured to hold the induction coil and including a heat dissipation unit for dissipating heat emitted by the induction coil.

15. The induction cooking appliance apparatus of claim 14, constructed in the form of an induction hob apparatus.

16. The induction cooking appliance apparatus of claim 14, wherein the coil carrier is embodied in one piece.

17. The induction cooking appliance apparatus of claim 14, wherein the heat dissipation unit includes a rib-shaped first heat dissipation element.

18. The induction cooking appliance apparatus of claim 17, wherein the heat dissipation unit includes a rib-shaped second heat dissipation element.

19. The induction cooking appliance apparatus of claim 18, wherein the first heat dissipation element is arranged at least substantially parallel to the second heat dissipation element.

20. The induction cooking appliance apparatus of claim 17, wherein the first heat dissipation element is oriented radially outward.

21. The induction cooking appliance apparatus of claim 17, wherein the coil carrier includes a recess for guiding away heated air in an outer end region of the first heat dissipation element.

22. The induction cooking appliance apparatus of claim 14, wherein the heat dissipation unit includes at least two heat dissipation sections arranged at a distance from one another.

23. The induction cooking appliance apparatus of claim 22, wherein the heat dissipation sections are arranged symmetrically to one another.

24. The induction cooking appliance apparatus of claim 14, wherein the heat dissipation unit includes a plastic material with a thermal conductivity of at least 0.2 W/(K m).

25. The induction cooking appliance apparatus of claim 14, wherein the heat dissipation unit is made of a plastic material with a thermal conductivity of at least 0.2 W/(K m).

26. The induction cooking appliance apparatus of claim 24, wherein the plastic material has a temperature resistance of at least 200° C.

27. The induction cooking appliance apparatus of claim 25, wherein the plastic material has a temperature resistance of at least 200° C.

28. The induction cooking appliance apparatus of claim 14, wherein the heat dissipation unit includes a coating to improve the thermal conductivity.

29. An induction cooking appliance, comprising an induction cooking appliance apparatus, said induction cooking appliance apparatus comprising an induction coil, and a coil carrier configured to hold the induction coil and including a heat dissipation unit for dissipating heat emitted by the induction coil.

30. The induction cooking appliance of claim 29, constructed in the form of an induction hob.
